(19) United States
(12) Patent Application Publication
(10) Pub. No.: US 2009/0315472 A1
(43) Pub. Date: Dec. 24, 2009

(54) BACKLIGHT MODULE

(75) Inventors: CHI-HSIUNG LEE, Jhongli City (TW); HUNG-CHANG LIANG, Jhongli City (TW); YU-HSIAO CHAO, Jhongli City (TW)

Correspondence Address: PCE INDUSTRY, INC.;ATT. Steven Reiss, 288 SOUTH MAYO AVENUE, CITY OF INDUSTRY, CA, 91789, US

(73) Assignee: AMPOWER TECHNOLOGY CO., LTD., Jhongli City (TW)

(21) Appl. No.: 12/417,600

(22) Filed: Apr. 2, 2009

(30) Foreign Application Priority Data
Jun. 20, 2008 (CN) 200810067944.5

(51) Int. Cl. H05B 41/16

(52) U.S. Cl. 315/276

(57) ABSTRACT

A backlight module positioned on a printed circuit board (PCB) includes a power control circuit, a transformer, and a voltage detection component. The power control circuit outputs power signals. The transformer has a primary winding and at least one secondary winding. The primary winding is connected to the power control circuit and receives the power signals. The voltage detection component is positioned on a high voltage terminal of the secondary winding of the transformer, detecting voltage variations in the high voltage terminal of the secondary winding of the transformer, and outputting the detected voltage variation to the power control circuit. The power control circuit adjusts the output power signals according to the detected voltage variation.

### BACKGROUND

1. Field of the Invention

Embodiments of the present disclosure relate to backlight modules, and particularly to a backlight module with voltage protection.

2. Description of Related Art

Voltage protection systems are often integrated in backlight modules. FIG. 5 shows a commonly used light source driving device driving a light source module 12, comprising a power control circuit 11, a transformer T1, a first capacitor C1 and a second capacitor C2. The power control circuit 11 comprises a power stage circuit 110, a control circuit 111, and a protection circuit 112.

In the power stage circuit 110, the first capacitor C1 and the second capacitor C2 are connected in series between a high voltage terminal of the secondary winding of the transformer T1 and ground, dividing a voltage of the high voltage terminal of the secondary winding of the transformer T1. The protection circuit 112 is connected to a junction of the first capacitor C1 and the second capacitor C2, outputting a protection signal according to the divided voltage. The control circuit 111 is connected between the power stage circuit 110 and the protection circuit 112, outputting a control signal to control output of the power stage circuit 110 according to the protection signal.

In use, the first capacitor C1 is frequently a high voltage component or stray capacitors in different layers of a printed circuit board (PCB) carrying the driving device, forming a voltage dividing circuit with the second capacitor C2. Thus, the voltage of the secondary winding of the transformer T1 can be detected, and the output of the power stage circuit 110 can be controlled. However, the high voltage component capacitor C1 has a larger volume, which increases cost and enlarges size of the PCB. In addition, if the first capacitor C1 includes the stray capacitor of the PCB, the PCB will include at least two layers, further increasing costs.

### BRIEF DESCRIPTION OF THE DRAWINGS

FIG. 1 is a block diagram of a backlight module in accordance with the present disclosure;

FIG. 2 is a schematic diagram of a first embodiment of a backlight module in accordance with the present disclosure;

FIG. 3 is a schematic diagram of a second embodiment of a backlight module in accordance with the present disclosure;

FIG. 4 is a schematic diagram of a third embodiment of a backlight module in accordance with the present disclosure;

FIG. 5 is a block diagram of a commonly used backlight module.

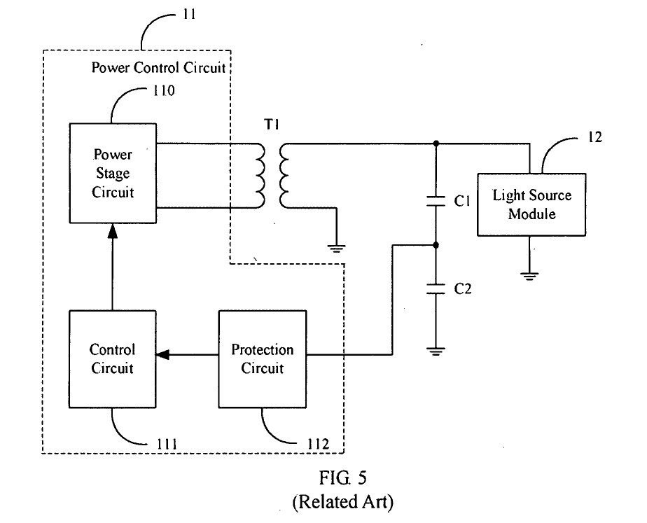

### DETAILED DESCRIPTION OF CERTAIN INVENTIVE EMBODIMENTS

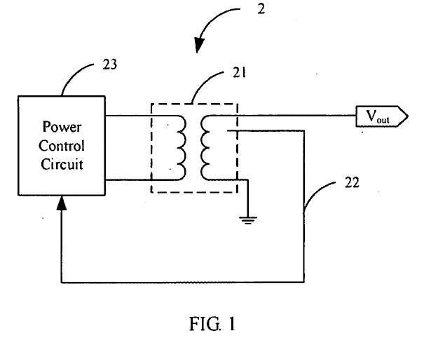

FIG. 1 is a block diagram of a backlight module 2 in accordance with the present disclosure. In one embodiment, the backlight module 2 comprises a transformer 21, a voltage detection component 22 and a power control circuit 23. The power control circuit 23 outputs power signals.

The transformer 21 comprises a primary winding and at least one secondary winding. The primary winding of the transformer 21 is connected to the power control circuit 23 and receives the power signals. The voltage detection component 22 is positioned close to a high voltage terminal of the secondary winding of the transformer 21, to detect voltage variation of the high voltage terminal of the secondary winding of the transformer 21 by electromagnetic induction. The power control circuit 23 adjusts output power signals according to the detected voltage variation.

When the backlight module 2 is in a normal state, the high voltage terminal of the secondary winding of the transformer 21 outputs a higher AC signal having a voltage of more than 1000V, in one example. Thus, the AC signal can generate a stronger electromagnetic field during transmission and excite free electrons. The voltage detection component 22, acting as a conductor in the electromagnetic field, can detect the AC signal and receive the free electrons, such that voltage variation in the high voltage terminal of the secondary winding of the transformer 21 is detected.

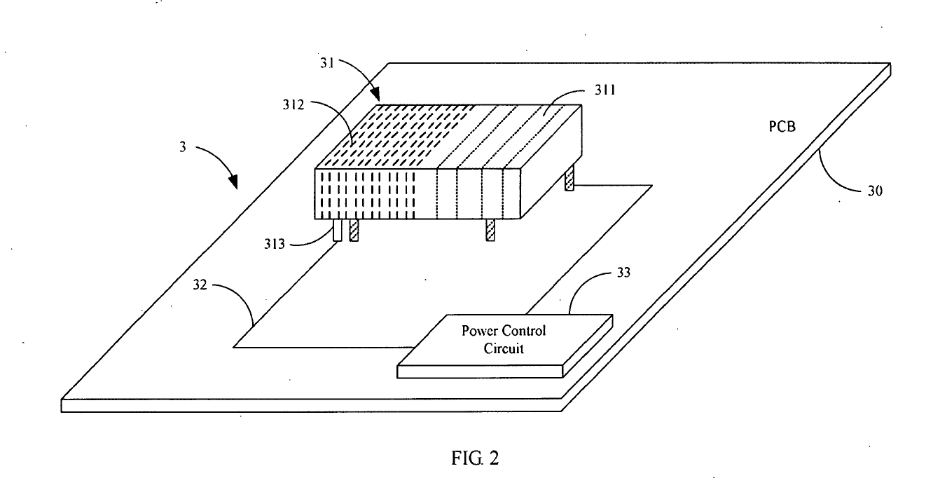

FIG. 2 is a schematic diagram of a first embodiment of a backlight module 3 in accordance with the present disclosure. The backlight module 3 is positioned on a printed circuit board (PCB) 30. The backlight module 3 comprises a transformer 31, a voltage detection component 32, and a power control circuit 30. The power control circuit 33 outputs power signals.

The transformer 31 comprises a primary winding 311 and at least one secondary winding 312. The primary winding 311 of the transformer 31 is connected to the power control circuit 33 for receiving the power signals. Here, the transformer 31 has a free pin 313. It may be understood that transformers often have a plurality of pins, where some pins are used to wrap windings of the transformers, and other pins are used as backup pins to balance electrical characteristics of the transformer. These backup pins may be free pins, in one example. Here, one end of the free pin 313 is embedded in the transformer 31, and the other end of the free pin 313 is exposed in the transformer 31 and is electrically connected to the PCB 30.

The voltage detection component 32 is positioned close to the high voltage terminal of the secondary winding 312 of the transformer 31, for detecting voltage variation in the high voltage terminal of the secondary winding 312 by electromagnetic induction, and transmitting the detected voltage variation to the power control circuit 33. In the illustrated embodiment, the voltage detection component 32 is a signal line positioned on the PCB 30 and connected to the free pin 313 of the transformer 31, for detecting voltage variation in the high voltage terminal of the secondary winding 312 of the transformer 31 by electromagnetic induction via the free pin 313.

The power control circuit 33 adjusts output power signals according to the detected voltage variation.

When the backlight module 3 is in a normal state, the high voltage terminal of the secondary winding 312 of the transformer 31 outputs a higher AC signal having a voltage of more than 1000V, in one example. Thus, the AC signal generates an increased electromagnetic field during transmission and excites free electrons. The signal line 32, acting as a conductor in the electromagnetic field, detects the AC signal and receives the free electrons via the free pin 313. Thus, voltage variation of the high voltage terminal of the secondary winding 312 of the transformer 21 is detected.

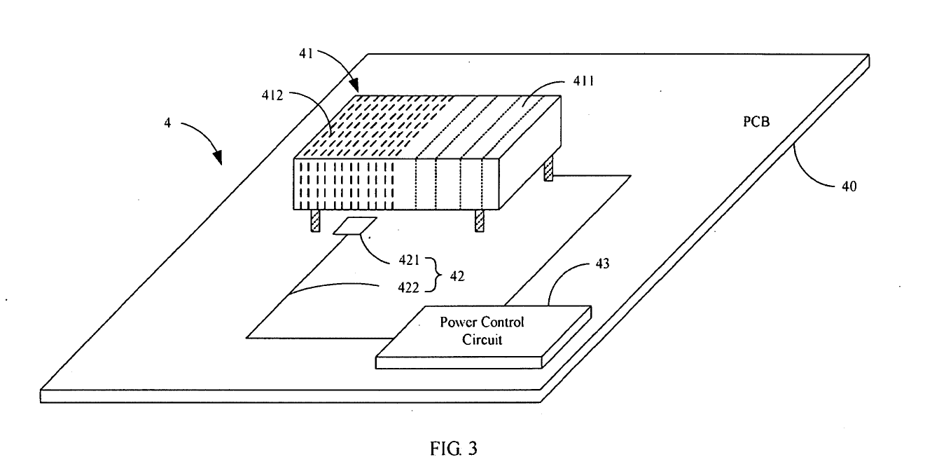

FIG. 3 is a schematic diagram of a second embodiment of a backlight module 4 in accordance with the present disclosure. The backlight module 4 is positioned on the PCB 40. The backlight module 4 comprises a transformer 41, a voltage detection component 42, and a power control circuit 43. The power control circuit 43 outputs power signals.

The transformer 41 comprises a primary winding 411 and at least one secondary winding 412. The primary winding 411 of the transformer 41 is connected to the power control circuit 43.

The voltage detection component 42 is positioned close to a high voltage terminal of the secondary winding 412 of the transformer 42, for detecting voltage variation of the high voltage terminal of the secondary winding 412 by electromagnetic induction, and transmitting the detected voltage variation to the power control circuit 43. In the illustrated embodiment, the voltage detection component 42 comprises a copper foil 421 and a signal line 422. The copper foil 421 is set on the PCB 40, and positioned close to the high voltage terminal of the secondary winding 412 of the transformer 41, for detecting voltage variation of the high voltage terminal of the secondary winding 412 by electromagnetic induction. One end of the signal line 422 is connected to the copper foil 421, and the other end thereof is connected to the power control circuit 43, for outputting the detected voltage variation to the power control circuit 43.

The power control circuit 43 adjusts output power signals according to the detected voltage variation.

When the backlight module 3 is in a normal state, the high voltage terminal of the secondary winding 412 of the transformer 41 outputs a higher AC signal having a voltage of more than 1000V, in one example. As mentioned above, the AC signal can generate a stronger electromagnetic field during transmission and excite free electrons. The copper foil 421 of the voltage detection component 42, acting as a conductor in the electromagnetic field, can detect the AC signal and receive the free electrons. Thus, the voltage variation of the high voltage terminal of the secondary winding 412 of the transformer 41 is detected.

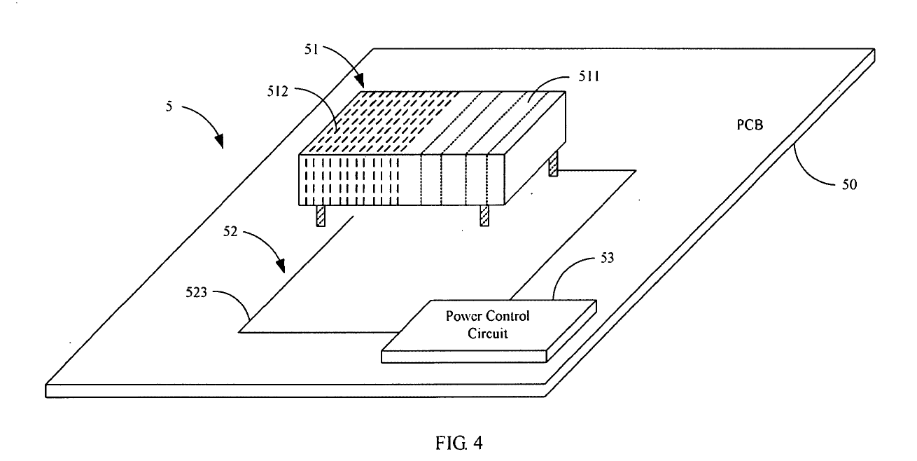

FIG. 4 is a schematic diagram of a third embodiment of a backlight module 5 in accordance with the present disclosure, differing from that of FIG. 3 only in the inclusion of a detecting signal line 523. The detecting signal line 523 is positioned on the PCB 50. One end of the detecting signal line 523 is positioned close to the high voltage terminal of the secondary winding 512 of the transformer 51 detecting voltage variation of the high voltage terminal of the secondary winding 512, with the other end connected to the power control circuit 53.

When the backlight module 5 is in a normal state, the high voltage terminal of the secondary winding 512 of the transformer 51 outputs a higher AC signal having a voltage of more than 1000V. As mentioned above, the AC signal can generate a stronger electromagnetic field during transmission and excite free electrons. The detecting signal line 523, acting as a conductor in the electromagnetic field, can detect the AC signal and receive the free electrons. Thus, the voltage variation of the high voltage terminal of the secondary winding 512 of the transformer 51 is detected.

In the disclosure, the detecting signal lines 32, 42, 52 detect voltage variation of the high voltage terminal of the secondary winding 312, 412, 512 of the transformer 31, 42, 52 reducing the quantity of components required. In addition, the backlight module 3, 4, 5 use a single PCB to decrease costs.

While various embodiments and methods of the present disclosure have been described above, it should be understood that they have been presented by way of example only and not by way of limitation. Thus the breadth and scope of the present disclosure should not be limited by above-described embodiments, but should be defined only in accordance with the following claims and their equivalents.

What is claimed is:

1. A backlight module positioned on a printed circuit board (PCB), comprising:
a power control circuit that outputs power signals;
a transformer comprising a primary winding and at least one secondary winding, wherein the primary winding is connected to the power control circuit to receive the power signals; and
a voltage detection component positioned on a high voltage terminal of the secondary winding of the transformer, configured for detecting voltage variation of the high voltage terminal of the secondary winding of the transformer, and outputting the detected voltage variation to the power control circuit;
wherein the power control circuit adjusts the output power signals according to the detected voltage variation.

2. The backlight module as claimed in claim 1, wherein the transformer comprises a free pin, wherein one end of the free pin is embodied in the transformer, and the other end of the free pin is exposed in the transformer and electrically connected to the PCB.

3. The backlight module as claimed in claim 2, wherein the voltage detection component comprises a signal line electrically connected to the other end of the free pin, to detect voltage variation of the high voltage terminal of the secondary winding.

4. The backlight module as claimed in claim 1, wherein the voltage detection component comprises:
a copper foil positioned on the PCB and positioned close to the high voltage terminal of the secondary winding of the transformer, the copper foil for detecting voltage variation of the high voltage terminal of the secondary winding; and
a signal line connecting the foil with the power control circuit, the signal line configured for transmitting the detected voltage variation to the power control circuit.

5. The backlight module as claimed in claim 1, wherein the voltage detection component comprises a detecting signal line positioned on the PCB, wherein one end of the detecting signal line is positioned close to the high voltage terminal of the secondary winding of the transformer, for detecting voltage variation of the high voltage terminal of the secondary winding, and wherein the other end of the detecting signal line is connected to the power control circuit.
